(19) United States
(12) Patent Application Publication
(10) Pub. No.: US 2008/0288807 A1
(43) Pub. Date: Nov. 20, 2008

(54) SYSTEM, METHOD, AND COMPUTER PROGRAM FOR PRESENTING AND UTILIZING FOOTPRINT DATA AS A DIAGNOSTIC TOOL

(76) Inventors: Michael Edward Lyons, Round Rock, TX (US); Michael Gerard Mall, Round Rock, TX (US); Bruce G. Mealey, Austin, TX (US)

Correspondence Address: IBM CORP (YA);C/O YEE & ASSOCIATES PC, P.O. BOX 802333, DALLAS, TX, 75380, US

(21) Appl. No.: 11/750,728

(22) Filed: May 18, 2007

(51) Int. Cl. G06F 11/00

(52) U.S. Cl. 714/2; 714/E11.007

(57) ABSTRACT

A data processing system for storing and identifying footprint data in a data processing system enabling automated collection, identification and formatting recovery of footprint data executing on a mainline routine. A footprint area is allocated onto a failure recovery routine stack for use by the mainline routine for storing footprint data. The mainline routine stores footprint data within the first footprint area. The data processing system can then receive a request from a diagnostic tool, where the request includes at least one search parameter. The data processing system can output any footprint data to a diagnostic tool corresponding to the search parameters in the request.

### BACKGROUND OF THE INVENTION

1. Field of the Invention

The present invention relates generally to an improved data processing system and in particular to a method and apparatus for processing data. Still more particularly, the present invention relates to a computer implemented method, apparatus, and computer usable program code presenting and utilizing footprint data obtained in a recovery environment as a diagnostic tool.

2. Description of the Related Art

Computers are generally, by nature, deterministic machines, but they must operate in a non-deterministic world. Hardware malfunctions, invalid data or instructions, unpredictable user input, and even cosmic radiation from the farthest reaches of outer space can influence the behavior of a computer system in undesirable ways. Ultimately, any truly useful computer system is capable, whether by programming, user input, or hardware malfunction, of producing an undesired result. This undesired result may be in many cases no result at all. For example, one of the fundamental results of computability theory is that it is, in the general case, impossible to determine with certainty whether a given program of instructions will terminate or enter into an infinite loop on a given input.

Thus, all useful computers must react at some level to asynchronous, non-deterministic, or otherwise unpredictable events, even if such reaction takes the form of a system crash or hang condition. One of the aims of most operating systems and other runtime environments is to avoid the occurrence of crashes and hangs. For example, most modern operating systems can terminate an application process in the event that the application performs an invalid or illegal instruction or memory access. In these instances, the computer hardware will generally detect the offending instruction or memory operation and raise an exception, causing an interrupt handling routine in the operating system to take notice of the exception and deal with it accordingly, often by terminating the application.

Of course, an operating system kernel is itself a computer program and is capable of experiencing the same malfunctions and other problems as any other computer program. The main distinguishing trait of an operating system kernel is that once the kernel crashes or hangs, usually the entire computer system will crash or hang. Thus, it is imperative for the stability of a computer system that kernel crashes and hangs are avoided at all costs.

Some operating systems, such as the AIX operating system (a product of International Business Machines Corporation), allow certain locations in kernel code to be designated as reentry points in the event of certain types of failure. In AIX, for example, a call to the function “setjmpx( )” allows the current location in the kernel code to be designated as the reentry point on failure. Such facilities allow some errors to be addressed within the kernel code by reentering the kernel code at the designated point with a failure code, but they are limited in the types of failure from which recovery can be performed. In particular, the “setjmpx( )” approach can not appropriately recover from failures that require significant state information to restore code functionality. Those failures can be dealt with by storing state information about the system.

Significant state information saved for kernel failure recovery and other system recovery failures can provide valuable data about a mainline routine's transactions and progress. Being able to collect active data regarding the state information from a system would allow the data to be used in other diagnostic processes.

### SUMMARY OF THE INVENTION

Systems and methods are provided for recalling and formatting stored footprint data in a data processing system enabling automated collection, identification and formatting of the footprint data. A data processing system executes a mainline routine. A footprint area is allocated onto a failure recovery routine stack for use by the mainline routine for storing footprint data. A footprint identifier to be associated with the footprint area is received at the time the footprint area is allocated. The mainline routine stores footprint data within the first footprint area. The data processing system can then receive a request from a diagnostic tool, where the request includes at least one search parameter. The data processing system can output any footprint data to a diagnostic tool corresponding to the search parameters in the request. The footprint identifier is then used to format the footprint data into an understandable format, from which valuable data about a mainline routine's transactions and progress can be determined.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system is shown in which illustrative embodiments may be implemented;

FIG. 2 is a block diagram of a data processing system that may be implemented as a server in accordance with a preferred embodiment of the present invention;

FIG. 3 is a high level pictorial flow of data through the various components in accordance with an illustrative embodiment of the current invention;

FIG. 4 is a flowchart representation of a process for executing a routine of for adding new footprint data to a footprint area on the Failure Recovery Routine stack in accordance with an illustrative embodiment of the current invention;

FIG. 5 is a flowchart representation of a process for executing a routine at a client for searching and recalling footprint data in accordance with an illustrative embodiment of the current invention; and

FIG. 6 is a diagram of an example listing of an operating system kernel code in the C programming language employing the failure recovery technology in accordance with an illustrative embodiment of the current invention.

### DETAILED DESCRIPTION OF THE PREFERRED EMBODIMENT

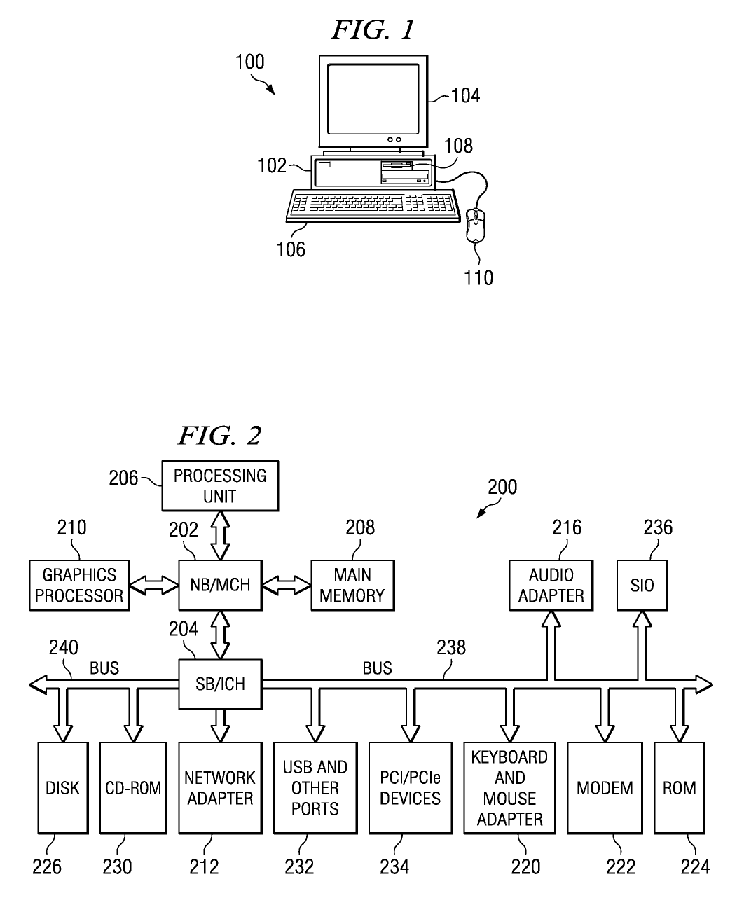

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices could include, for example, a joystick, a touchpad, a touch screen, a trackball, and a microphone.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a Step diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) and other ports 232. PCI/PCIe devices 234 are coupled to south bridge and I/O controller hub 204 through bus 238. Hard disk drive (HDD) 226 and CD-ROM 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206. This operating system coordinates and controls various components within data processing system 200 in FIG. 2. The operating system may be a commercially available operating system, such as Microsoft® Windows XP® or IBM® AIX® (Microsoft® and Windows XP® are trademarks of Microsoft Corporation in the United States, other countries, or both; IBM® and AIX® are trademarks of International Business Machines Corporation in the United States, other countries, or both). An object oriented programming system, such as the Java programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processing unit 206. The processes of the illustrative embodiments may be performed by processing unit 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

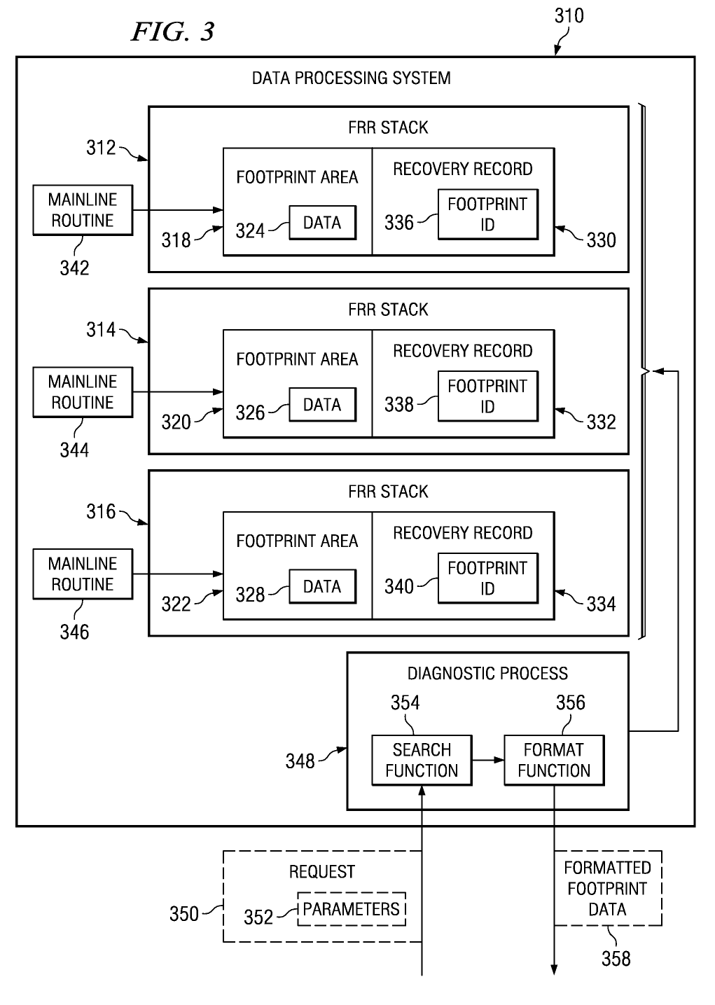

Referring now to FIG. 3, a high level pictorial flow of data is shown through the various components in accordance with an illustrative embodiment of the current invention. Data processing system 310 can be any data processing system capable of executing the current invention, such as data processing system 200 of FIG. 2.

Failure Recovery Routine Stacks (herein after “FRR stacks”) 312-316 are the areas of storage managed as a stack that contain mainline code recovery data. FRR stacks 312-316 contain footprint areas 318-322 where footprint data 324-328 are stored. FRR stacks 312-316 can also include other information, such as recovery control information (not shown). Recovery control information, such as the Failure Recovery Routines (FRRs), idenfity code that receives control of mainline routines 342-346 in the event of an exception.

According to one illustrative embodiment, every thread running a mainline routine 342-346 within the operating system will have an FRR stack. That is, every thread running mainline routine 342-346 will have a FRR stack 312-316 pinned thereto. By providing each mainline routine 342-346 with its own FRR stack 312-316, FRR stacks 312-316 can be preserved when mainline routines 342-346 are suspended due to an exception or other event. Furthermore, FRR stacks 312-316 should be pinned because processing will often be running disabled and referencing its FRR stack 312-316.

In a preferred embodiment, FRR stacks 312-316 are an exhaustible resource, and have a predetermined maximum size. All allocations perform inline checks to determine whether an allocation to one of FRR stacks 312-316 will overflow the predetermined maximum size of the respective FRR stack 312-316.

Footprint areas 318-322 are allocated for an FRR when the FRR is created. Footprint areas 318-322 are areas of storage where a component can track the execution of its mainline code.

When one of mainline routines 342-346 is executed by a thread, mainline routines 342-346 use a service, such as the frr_add( ) function described herein, to establish recovery. The frr_add( ) service puts mainline routine's 342-346 recovery routine on the corresponding one of FRR stacks 312-316. The frr_add( ) service allocates and zeroes footprint data 324-328 on the corresponding one of FRR stacks 312-316 for mainline routines 342-346 to use. The frr_add( ) service also saves mainline routines 342-346 reentry point data on the corresponding FRR stack 312-316. The frr_add( ) service returns a code of zero to indicate the frr_add( ) service completed successfully and that mainline routines 342-346 processing should continue.

Footprint data 324-328 stored within footprint areas 318-322 typically consists of information that may be useful in the recovery from an exception. Footprint data 324-328 are typically used by mainline routines 342-346 to track a processing state for use by recovery code. A recovery routine will use this information to determine what was happening in mainline routines 342-346 when the error occurs. Footprint data 324-328 may include, but is not limited to reentry identifiers for reentering the stack upon recovery from an exception, addresses of locks held by the mainline, addresses of dynamically acquired storage, parameters passed to the mainline, flags that track the mainline execution progress, and addresses of other important data areas. At a minimum, footprint data 324-328 should contain enough state to allow mainline routines 342-346 to understand what reentry point is active for a given function in the event of an exception.

Footprint data 324-328 are stored by mainline routines 342-346 in footprint areas 318-322. Diagnostic process 348 is provided access to footprint areas 318-322 and can view this information. By allowing diagnostic process 348 to view the footprint data 324-328 outside of a recovery routine, a developer can leverage mainline routines 342-346 footprint data 324-328, normally used to implement recovery of mainline routines 342-346, to also provide useful diagnostic data. For example, if a kernel routine typically experiences an exception due to the routine failing to release “read lock,” the developer can utilize footprint data 324-328 to determine which thread currently owns the lock. The developer could also make adjustments to the kernel routine to avoid similar future exceptions.

Recovery records 330-334 to save footprint identifiers (hereinafter “footprint IDs”) 336-340 are provided for and associated with footprint areas 318-322 on a one-to-one basis. When FRR stacks 312-316 are created, corresponding recovery records 330-334 for footprint IDs 336-340 are allocated and associated with each footprint area 318-322. Footprint IDs 336-340 identify a format of corresponding footprint areas 318-322. Typically, each of mainline routines 342-346 that provides recovery will have a format unique to its corresponding footprint area 318-322. A developer coding mainline routines 342-346 assigns a unique footprint ID to identify the format of footprint areas 318-322.

Footprint IDs 336-340 are typically provided on a one-to-one basis for each mainline routine 342-346. Footprint IDs 336-340 serve as a formatting key that allows a user or developer to make sense from the footprint data 324-328 stored on FRR stacks 312-316.

Footprint IDs' 336-340 primary purpose is to identify footprint areas 318-322 and provide a formatting tool for footprint data 324-328 stored therein. Footprint data 324-328 is stored within footprint areas 318-322 in a format typically unknown to a developer or an outside program parsing footprint data 324-328. Footprint IDs 336-340 provide the formatting key with which a developer or an external program can make sense of the footprint data 324-328.

Footprint IDs 336-340 are stored in a corresponding recovery record 330-334, each recovery record being associated with a corresponding footprint area 318-322. Footprint areas 318-322 of FRR stacks 312-316 are therefore allocated with an associated recovery record 330-334. Footprint areas 318-322 contain footprint data 324-328 needed by the recovery framework. Recovery records 330-334 contain the associated footprint IDs 336-340. Upon recall of the footprint IDs 336-340, the search query is directed to the corresponding footprint areas 318-322.

In an illustrative embodiment, a single one of FRR stacks 312-316 is maintained for each of thread running mainline routines 342-346. When one of the mainline routines 342-346 is executed, the frr_add( ) call allocates a footprint area 318-322 on the corresponding FRR stack 312-316 to contain footprint data 324-328. Similarly, recovery records 330-334, also provided on FRR stacks 312-316, contain footprint IDs 336-340 necessary to identify footprint data 324-328 within footprint areas 318-322 needed by a recovery framework for recovery processing of mainlines routine 342-346.

In one illustrative embodiment, mainline routines 342-346 may store footprint data 324-328 directly into footprint areas 318-322. Mainline routines 342-346 do not need to use any special functions or macros to store footprint data 324-328. However, in this embodiment, mainline routines 342-346 should be aware that the compiler may generate stores to mainline data and footprint data 324-328 in a different order than the programming conceptual order.

Diagnostic process 348 is a software process running on a data processing system such as data processing system 200 of FIG. 2. Diagnostic process 348 can be executed locally, or can be executed on a separate data processing system that is provided with access to footprint areas 318-322 and recovery records 330-334 included on FRR stacks 312-316. Diagnostic process 348 identifies footprint data 324-328 either through a static address for FRR stacks 312-316 or by determining an address for associated footprint IDs 336-340.

Diagnostic process 348 can receive a request 350 including search parameters 352 from a user. Search parameters 352 can specify any information included in footprint data 324-328, such as reentry IDs for reentering FRR stacks 312-316 upon recovery from an exception, addresses of locks held by mainline routines 342-346, addresses of dynamically acquired storage, parameters passed to mainline routines 342-346, flags that track execution progress of mainline routines 342-346, and addresses of other important data areas.

Responsive to receiving request 350 from the user, diagnostic process 348 executes search function 354. Recovery records 330-334, containing footprint IDs 336-340 have an address determinable by search function 354. Search function 354 determines from recovery records 330-334 and footprint areas 318-322 at least those of footprint data 324-328 that correspond to the search parameters 352. For example, if a file system on one of mainline routines 342-346 footprints an inode address, search function 354 can search footprint areas 318-322 that contain footprint data 324-328 including that inode address.

In an illustrative embodiment, FRR stacks 312-316 are provided at known addresses. Recovery records 330-334 can then be found by scanning all known FRR stacks 312-316. Once recovery records 330-334 are found, footprint IDs 336-340 indicate that footprint data 324-328 correspond to search parameters 352. Footprint data 324-328 can then be examined. Footprint data 324-328 and footprint IDs 336-340 used to decipher the footprint data 324-328 are available to the developer for inspection.

Footprint data 324-328 that is returned by search function 354 can then be formatted by formatting function 356 to allow the developer to view the footprint data 324-328 in a format that corresponds to the request 350. Footprint IDs 336-340 are utilized by formatting function 356 to format footprint data 324-328 into an intelligible format. Footprint data 324-328 is initially stored within footprint areas 318-322 in a format typically unknown to a developer or an outside program parsing footprint data 324-328. Footprint IDs 336-340 provide the formatting key with which a developer or an external program can make sense of footprint data 324-328. Footprint data 324-328 is then formatted into formatted footprint data 358 to intelligibly show information about the transactions and progress of mainline routines 342-346.

Formatted footprint data 358 is then displayed to the developer. The automatic collection of footprint data 324-328, and the search and retrieval thereof, allows the developer to leverage footprint data 324-328 as a diagnostic tool in performing exception analysis for system processes. Automatic collection and analysis of footprint data 324-328 allows recovery of footprint data 324-328 to be used as a per-context trace facility.

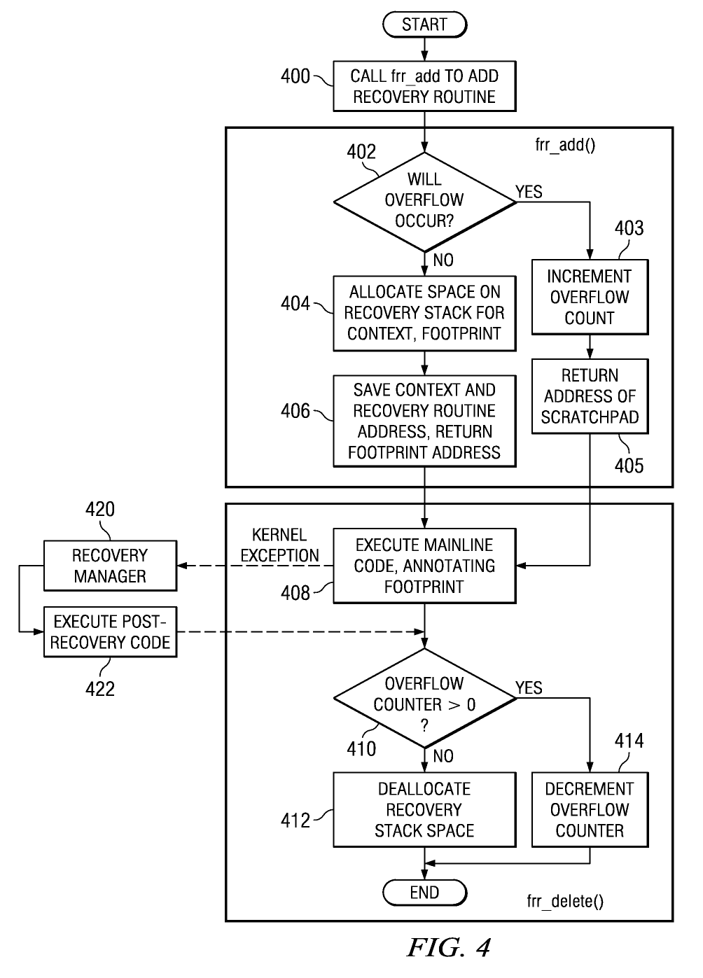

Referring now to FIG. 4, a flowchart representation of a process for executing a routine of for adding new footprint data to a footprint area on the FRR stack is shown in accordance with the illustrative embodiments. Process 400 can be implemented as a software process on a data processing system. Process 400 can be one of mainline routines 342-346 shown in FIG. 3. Data processing system can be data processing system 200 shown in FIG. 2.

Footprint data is added as recovery code by a function of the mainline code. The function, which can be the frr_add( ) function described herein, proceeds as follows:

If pushing/allocating the additional context information and footprint space needed to designate a recovery routine would cause the FRR stack to exceed the space allocated for it—i.e., make it overflow (“Yes” at step 402), then the frr_add( ) routine increments overflow counter (step 403) and returns the address of the footprint scratchpad instead of a stack allocated footprint area (step 405), thereby “virtually lengthening” the FRR stack.

If sufficient space exits for the information to be physically pushed onto the FRR stack, (“No” at Step 402), then recovery stack TOS pointer is adjusted to allocate the needed pace at the top of the recovery stack (Step 404). The context information (including the address of the designated recovery routine and the current value of barrier count) is the saved in the newly allocated space at the top of the stack and the address of the footprint area returned to the mainline routine that called the frr_add( ) (Step 406).

Once frr_addd( ) returns, the mainline code for the recovery-enabled routine executes (step 408). If during the execution of this mainline code, an exception is raised signifying some type of failure, recovery manager routine is called to attempt recovery. Once the recovery has taken place, any post-recovery code contained in the revocery-enabled routine is executed (step 422). Following mainline code execution (or failure recovery, as the case may be), at the end of the recovery-enabled routine, function frr_delete( ) is executed to reverse the effects of frr_add( ).

Function frr_delete( ) proceeds as follows: If the overflow counter is greater than zero (“Yes” at step 410), the overflow counter is decremented (Step 414). Otherwise (“No” at step 410), the recovery stack space allocated at Step 404 is reclaimed by adjusting recovery stack TOS pointer appropriately so as to effect a “pop” of the topmost context entry from FRR stack.

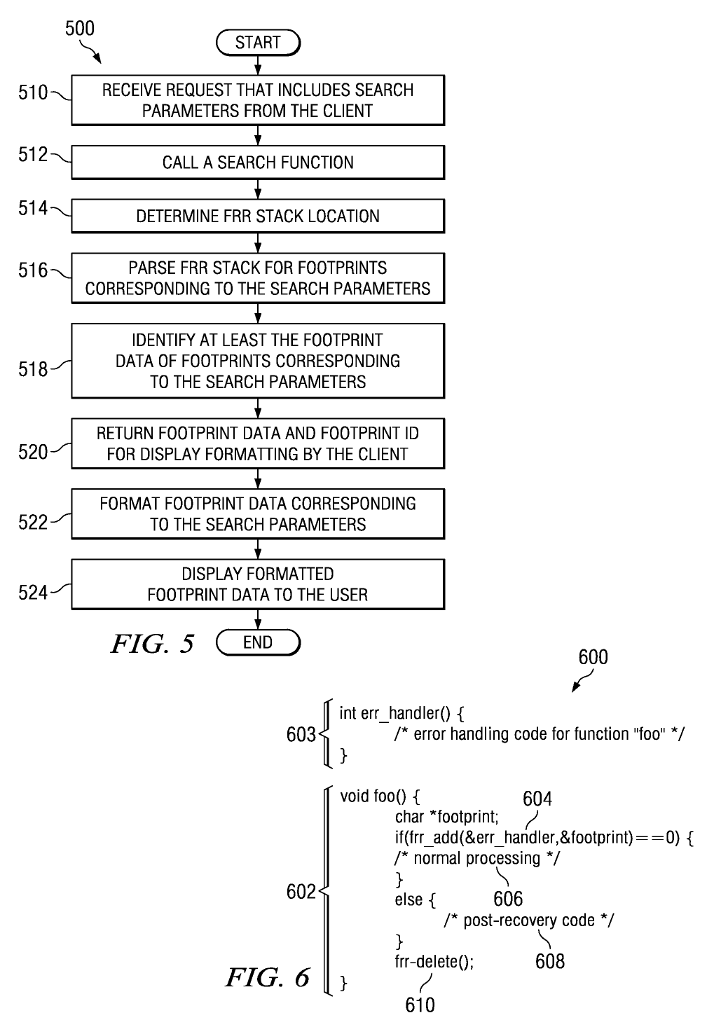

Referring now to FIG. 5, a flowchart representation of a process for executing a routine at a client for searching and recalling footprint data is shown in accordance with the illustrative embodiments. Process 500 can be implemented on a client, such as clients 110, 112 and 114 shown in FIG. 1. Process 500 is a software process, such as diagnostic process 348 in FIG. 3. Responsive to receiving a request that includes search parameters from the client (step 510), process 500 can then call a search function (step 512). The search function determines the location of FRR stacks (step 514). The search function then searches the FRR stack by parsing the recovery records and finding footprint areas that correspond to the search parameters (step 516). The search function then identifies at least the footprints data of footprints corresponding to the search parameters (step 518). For example, if the filesystem footprints an inode address, the search function can search all active footprints that contain footprint data including that inode address.

The search function returns the footprint data and footprint ID for display formatting by the client (step 520). It is to be understood that “returning the footprint data” can include returning the data, an address or pointer to the FRR stack on which the data is stored. Footprint data corresponding to the search parameters is then formatted (step 522). The formatted footprint data can then be displayed to the user (step 524), allowing the user to view the footprint data in a format that corresponds to the request, with the process terminating thereafter. Continuing with the above example, on retrieval of the footprint data for the inode address, active footprints can be formatted to show the contexts that are performing transactions on the inode.

The automatic collection of footprint data and search and retrieval thereof allows the user to leverage the footprint data as a diagnostic tool in performing exception analysis for kernel processes. Automatic collection and analysis of footprint data allows recovery of footprints to be used as a per-context trace facility.

Referring now to FIG. 6, a diagram of an example listing 600 of an operating system kernel code in the C programming language employing the failure recovery technology of an illustrative embodiment of the present invention. Listing 600 can be included in mainline routines 342-346 of FIG. 3.

Function foo( ) 602 is a routine for which recovery is enabled, i.e. a mainline routine. “If” statement 604 calls function “frr_add( )” which designates a failure recovery routine for function foo( ) 602, namely function err_handler( ) 603. Function frr_add( ) normally stores context information on the recovery stack, returns the address of a footprint area on the recovery stack, and returns a value 0 (zero) as the result (return value) of the function (a return value of zero being the C language convention for successful function completion), thus causing “then” compound statement 606 (inside curly braces) to be executed (since the comparison in “if” statement 604 evaluates to “true”). Compound statement 606 represents the mainline code of the function foo( ) 602 (i.e., the code performing the normal operations of function foo( ) 602).

In the event of a failure exception being raised during execution of compound statement 606, the designated recovery routine (in this case function err_handler( ) 603) will be executed to perform whatever actions are needed to recovery from the failure, and function foo( ) 602's execution will resume from “if” statement 604, as if returning from function “frr_add( ),” except that now a non-zero value is returned, thus causing the comparison in “if” statement 604 to evaluate to “false” and cause “else” compound statement 608 to be executed. Compound statement 608 contains post-recovery code to be executed only in the event of a failure exception and successful recovery reentry to mainline code. Finally (regardless of the evaluation of “if” statement 604), a call is made to function “frr_delete( )” at line 610 to disable the recovery routine and reclaim the recovery stack space used to store the context and footprint information used to enable failure recovery for function foo( ) 602.

Thus, the different illustrative embodiments provide systems and methods for storing and identifying footprint data in a data processing system enabling automated collection, identification and formatting recovery of footprint data. A data processing system executes a mainline routine. A first footprint area is allocated onto a failure recovery routine stack for use by the mainline routine for storing footprint data. The mainline routine stores footprint data within the first footprint area. The data processing system can then receive a request from a diagnostic tool, where the request includes at least one search parameter. The data processing system can output any footprint data to a diagnostic tool corresponding to the search parameters in the request.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for identifying footprint data in a data processing system, the method comprising:
executing a mainline routine;
allocating a first footprint area onto a failure recovery routine stack for use by the mainline routine;
storing a first footprint data within the first footprint area;
receiving a first request from a requestor, the first request including at least one search parameter; and
outputting the first footprint data to the requestor if the at least one search parameter is also included in the first footprint data.

2. The computer implemented method of claim 1, wherein the first footprint comprises information about the mainline, said information selected from one of reentry point data on the failure recovery routine stack, addresses of locks held by the mainline routine, addresses of dynamically acquired storage, parameters passed to the mainline routine, flags that track a mainline execution progress, addresses of other important data areas, and combinations thereof.

3. The computer implemented method of claim 1, further comprising associating a first footprint identifier with the first footprint area.

4. The computer implemented method of claim 3, wherein the first request includes a first reference to the first footprint identifier.

5. The computer implemented method of claim 1, further comprising:
allocating a second footprint area onto a failure recovery routine stack for use by the mainline routine;
storing second footprint data within the second footprint area; and
outputting the second footprint data to the requestor if the at least one search parameter is also included in the second footprint data.

6. The computer implemented method of claim 5, further comprising:
associating a first footprint identifier with the first footprint area, and associating a second footprint identifier with the second footprint area; and
wherein the first request includes at least one of a first reference to the first footprint identification identifier and at least one second reference to the second footprint identifier.

7. The computer implemented method of claim 1, wherein the at least one search parameter comprises information, said information selected from the list consisting of reentry point data on the failure recovery routine stack, addresses of locks held by the mainline routine, addresses of dynamically acquired storage, parameters passed to the mainline routine, flags that track a mainline execution progress, addresses of other important data areas, and combinations thereof.

8. The computer implemented method of claim 3, wherein the first footprint identifier enables the first footprint data within the first footprint area to be deciphered by the requestor.

9. A computer program product in a storage type medium for identifying footprint data in a data processing system, the computer program product comprising:
first instructions for executing a mainline routine;
second instructions for allocating a first footprint area onto a failure recovery routine stack for use by the mainline routine;
third instructions for storing a first footprint within the first footprint area;
fourth instructions for receiving a first request from a requestor, the first request including at least one search parameter; and
responsive to receiving the first request, fifth instructions for outputting the first footprint data to the requestor if the at least one search parameter is also included in the first footprint data.

10. The computer program product of claim 9, wherein the first footprint comprises information about the mainline, said information selected from one of reentry point data on the failure recovery routine stack, addresses of locks held by the mainline, addresses of dynamically acquired storage, parameters passed to the mainline routine, flags that track the mainline execution progress, addresses of other important data areas, and combinations thereof.

11. The computer program product of claim 9, further comprising sixth instructions for associating a first footprint identifier with the first footprint area.

12. The computer program product of claim 11, wherein the first request includes a first reference to the first footprint identifier.

13. The computer program product of claim 9, wherein the second instructions further comprise first sub-instructions for allocating a first footprint area onto a failure recovery routine stack for use by the mainline routine; wherein the third instructions further comprise second sub-instructions for storing a second footprint data within the second footprint area; and wherein the fourth instructions further comprise third sub-instructions for outputting the second footprint data to the requestor if the at least one search parameter is also included in the second footprint data.

14. The computer program product of claim 9, further comprising:
associating a first footprint identifier with the first footprint area, and associating a second footprint identifier with the second footprint area; and
wherein the first request includes at least one of a first reference to the first footprint identifier and a second reference to the second footprint identifier.

15. The computer program product of claim 9, wherein the at least one search parameter comprises information, said information selected from the list consisting of reentry point data on the failure recovery routine stack, addresses of locks held by the mainline routine, addresses of dynamically acquired storage, parameters passed to the mainline routine, flags that track a mainline execution progress, addresses of other important data areas, and combinations thereof.

16. The computer program product of claim 11, wherein the first footprint identifier enables the first footprint data within the first footprint area to be deciphered by the requestor.

17. A data processing system comprising:
a memory containing a set of instructions; and
a processor for executing the set of instructions, wherein executing the set of instructions comprises: executing a mainline routine; allocating a first footprint area onto a failure recovery routine stack for use by the mainline routine; storing a first footprint data within the first footprint area; receiving a first request from a requestor, the first request including at least one search parameter; and outputting the first footprint data to the requestor if the at least one search parameter is also included in the first footprint data.

18. The data processing system of claim 17, wherein the first footprint comprises information about the mainline, said information selected from one of reentry point data on the failure recovery routine stack, addresses of locks held by the mainline routine, addresses of dynamically acquired storage, parameters passed to the mainline routine, flags that track a mainline execution progress, addresses of other important data areas, and combinations thereof.

19. The data processing system of claim 17, wherein executing the set of instructions further comprises associating a first footprint identifier with the first footprint area.

20. The data processing system of claim 19, wherein the first footprint identifier enables the first footprint data within the first footprint area to be deciphered by the requestor.
